(19) United States
(12) Patent Application Publication
(10) Pub. No.: US 2014/0333590 A1
(43) Pub. Date: Nov. 13, 2014

(54) DIGITAL PEN

(71) Applicants: Koji Hirata, Ibaraki (JP); Tatsuya Ishikawa, Ibaraki (JP); Tsuneo Fujikura, Ibaraki (JP); Shuji Kato, Ibaraki (JP); Miyuki Ikeda, Ibaraki (JP); Yoshiho Seo, Tokyo (JP); Takashi Kanbara, Ibaraki (JP); Toshiyuki Kimoto, Ibaraki (JP)

(72) Inventors: Koji Hirata, Ibaraki (JP); Tatsuya Ishikawa, Ibaraki (JP); Tsuneo Fujikura, Ibaraki (JP); Shuji Kato, Ibaraki (JP); Miyuki Ikeda, Ibaraki (JP); Yoshiho Seo, Tokyo (JP); Takashi Kanbara, Ibaraki (JP); Toshiyuki Kimoto, Ibaraki (JP)

(73) Assignee: Hitachi Maxell, Ltd., Ibaraki-shi, Osaka (JP)

(21) Appl. No.: 14/374,859

(22) PCT Filed: Feb. 1, 2012
(86) PCT No.: PCT/JP2012/000653

§ 371 Date: Jul. 25, 2014

(51) Int. Cl. G06F 3/038; G06T 11/80; G06T 5/50; G06F 3/0354

(52) U.S. Cl. CPC G06F 3/0383; G06F 3/03545; G06T 11/80; G06T 5/50; G06T 2207/20221
USPC 345/179

(57) ABSTRACT

A digital pen includes a light emitting element configured to emit a light ray of a specific wavelength region; a pen tip configured to emit the light ray on a writing surface; a sensor configured to output information indicative of whether the pen tip contacts the writing surface; a controller configured to detect if the pen tip contacts the writing surface based on the information from the sensor; and a holding mechanism configured to hold pressure applied onto the sensor to be constant, through an elastic force of an elastic body. The controller determines that the pen tip contacts the writing surface when the sensor is free from the pressure, thereby dissolving a problem of an uncomfortable feeling for a user, which is caused by the fact that the track written by the digital pen is not immediately reflected on a screen.

### TECHNICAL FIELD

This application relates to a digital (or electronic) pen.

### BACKGROUND OF THE INVENTION

In recent years, a display apparatus having interactive functions comes to be used, widely, in a place of presentation, i.e., for a presenter to enable to show information, such as, drawings and/or characters, etc., additionally, on an original picture, being displayed on an electronic blackboard or the like. When installing this electronic blackboard (i.e., an interactive white board) together with a projector, a format picture, which was produced beforehand, is projected on a screen, and thereafter, a user makes correction or addition on the format picture.

In order to combine the picture added, which was made by the digital pen, with the format picture projected on the screen, on this electronic blackboard, there is necessity of providing a light emitting portion or an ultrasonic generator portion on the digital pen, while on the projector itself or the screen, a detector portion for the light or the ultrasonic or both of them, thereby to detect the position of the digital pen.

Herein, as a method for detecting the position of the digital pen is already known a technology (please refer to the Patent Document 1), for example, detecting the position of the digital pen, i.e., combining a super-wide angle lens and a semiconductor image pickup element, in the form of one piece of infrared receiver portion, so as to take the picture on the screen as the picture or video data, and thereafter, comparing it with the format picture, which is prepared beforehand.

### PRIOR ART DOCUMENTS

### Patent Documents

[Patent Document 1] Japanese Patent Laying-Open No. 2011-059768

### BRIEF SUMMARY OF THE INVENTION

### Problem(s) to be Dissolved by the Invention

With the Patent Document 1, the track written by the digital pen cannot be reflected on the screen, immediately, and therefore, this brings about a problem that feeling is not good for the user in the writing.

Then, an object, according to the present invention, lies to provide a digital pen for enabling to reflect the track written by the digital pen, quickly, on the screen.

### Means for Dissolving the Problem(s)

For dissolving such problem(s) as mentioned above, one of the preferable embodiments according to the present invention is as follows:

A digital pen, for outputting information relating to writing position, comprises: a light emitting element, which is configured to emit a light ray of a specific wavelength region; a pen tip portion, which is configured to emit said light ray on a writing surface of said digital pen; a sensor, which is configured to output information indicative of whether said pen tip portion and said writing surface are in contact with or not; a controller portion, which is configured to detect if said pen tip portion and said writing surface are in contact with or not, upon basis of the information outputted by said sensor; and a holding mechanism, which is configured to hold pressure applied onto said sensor to be constant, through an elastic force of an elastic body, wherein said controller portion determines that said pen tip portion and said writing surface are in contact with, when said sensor is free from the pressure, with which said sensor is held by said holding mechanism.

### EFFECT(S) OF THE INVENTION

According to the present invention, it is possible to provide the digital pen for enabling to reflect the track written by the digital pen, quickly, on the screen.

### BRIEF DESCRIPTION OF THE SEVERAL VIEWS OF THE DRAWING

FIG. 1 is a system configuration view;

FIGS. 2(A) and 2(B) are outlook views of a digital pen;

FIG. 3 is an exploded perspective view of an entire of the digital pen;

FIG. 4 is an exploded perspective view of an interior of the digital pen;

FIG. 5 is a cross-section view of the digital pen;

FIG. 6 is a detailed exploded perspective view of the interior of the digital pen;

FIGS. 7(A) and 7(B) are interior structural views of the digital pen;

FIGS. 8(A) to 8(C) are views for showing an example of arrangement of a pressure-sensitive sensor;

FIG. 9 is a view for showing a controller circuit of the digital pen;

FIG. 10 is a view for showing the characteristics of distribution of light emission of a light emitting element;

FIGS. 11(A) and 11(B) are views for showing the characteristics of the pressure-sensitive sensor;

FIG. 12 is a view for showing a projection video display apparatus of mirror folding-back type;

FIG. 13 is a view for showing the projection video display apparatus of mirror folding-back type;

FIG. 14 is a view for showing a front surface projection video display apparatus; and

FIG. 15 is a view for showing the front surface projection video display.

### EMBODIMENT(S) FOR CARRYING OUT THE INVENTION

Hereinafter, explanation will be on the embodiment(s), by referring to the drawings attached herewith.

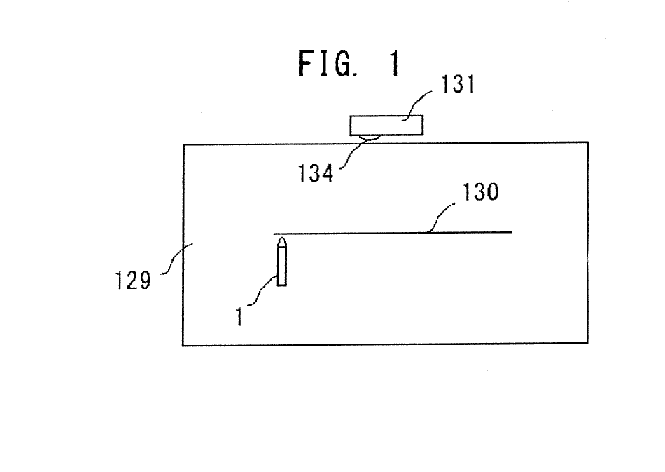

FIG. 1 is a system configuration view. This system comprises a projection-type video display apparatus (i.e., aprojector) 131, a light receiving portion (i.e., combination of a super-wide angle lens and a semiconductor image pickup element) 134 for receiving light rays of a specific wavelength range, which is provided within the projection-type video display apparatus 131, a writing surface (i.e., a whiteboard, or a screen of an electronic blackboard, etc.) 129, and a digital (or electronic) pen 1. Herein is shown a condition where a line 130 is drawn by an aid of the digital pen 1).

In the present embodiment, explanation will be made upon an assumption that the light rays having the specific wavelength range are infrared. The digital pen 1 emits the infrared from a pen tip when the user writes with it. The track virtually written by the user with an aid of the digital pen 1 is recognized by the light receiving portion 134, which receives the infrared is emitting from the digital pen 1. The light receiving portion 134 takes the infrared emitting from the digital pen 1 and the position thereof, i.e., where that infrared is emitted, therein, as the position information (video data) of the digital pen 1, and sends it to a drawing apparatus.

The drawing apparatus, upon receipt of that video data from the light receiving portion 134, executes a calculation process, i.e., comparing it with a format video, which is produced in advance. Thus, from the track of the position, from where the infrared is emitting (i.e., a writing position), being drawn by means of the digital pen 1, video data is produced in relation with the track recognized, and that video relating to the track is superimposed on an original video. And, the video data superimposed is transmitted to the projection-type video display apparatus 131. The projection-type video display apparatus 131 projects the video received herein, onto the screen 129. With doing this, the track written by the digital pen is displayed, as the result thereof.

The drawing apparatus may be built within the projection-type video display apparatus 131, or may be a PC (Personal Computer), which is connected with the projection-type video display apparatus 131.

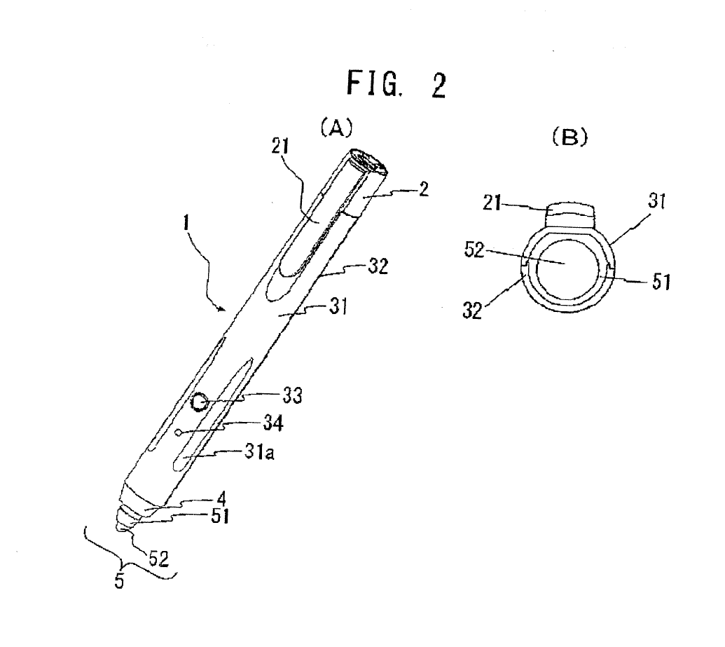

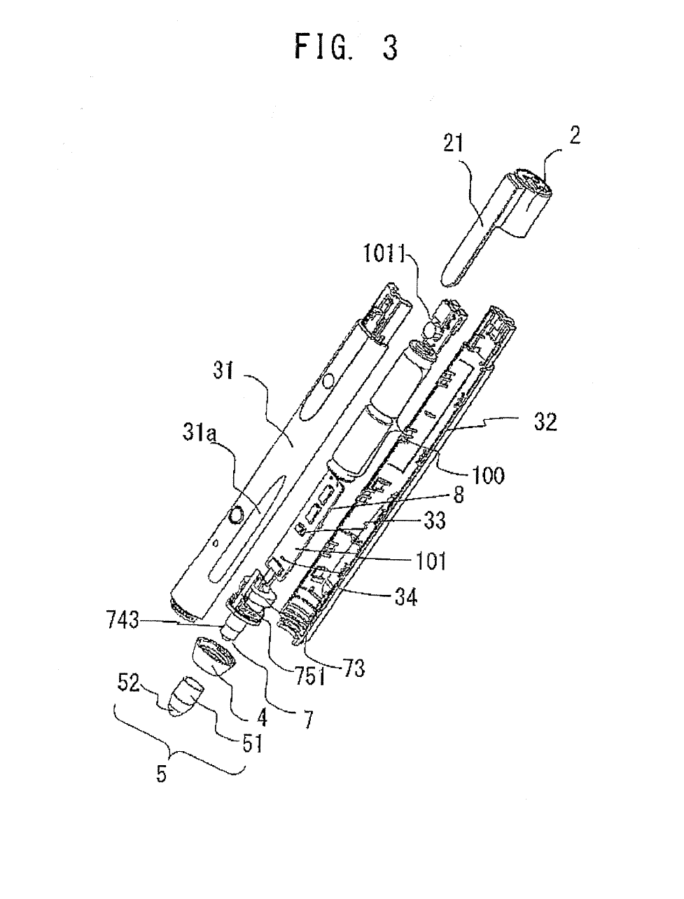

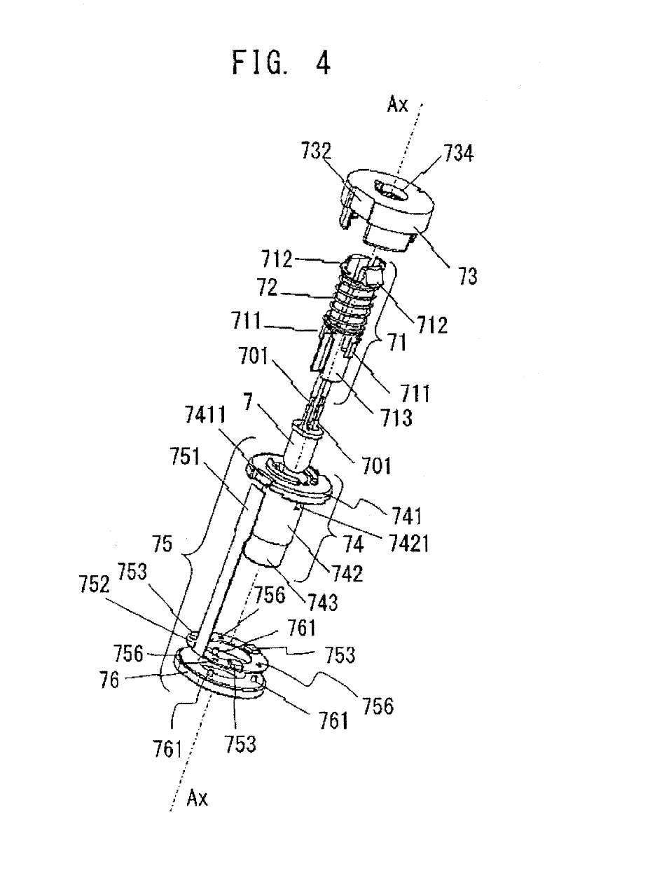

Next, explanation will be given on the structure of the digital pen 1. FIGS. 2(A) and 2(B) are an outlook views of the digital pen (wherein FIG. 2(A) is an outlook view of the entire thereof, and FIG. 2(B) is a view of being seen from the pen tip), FIG. 3 is an exploded perspective view of the entire of the digital pen, and FIG. 4 is an exploded perspective view of an interior of the digital pen, respectively.

The digital pen 1 has a shape mimicking so-called a pen to be used when writing, and it comprises a pen tip portion 5 (including a pen tip holder portion 51 and a pen tip 52), a holder (i.e., a cap) 4 of the pen tip portion 5, an upper housing portion 31, a lower housing portion 32, a cut-out portion 31a, an external switch 33, a display LED 34, a hook 21 and a pen rear tip 2.

The pen tip portion 5 is formed through inserting the pen tip 52 into the pen tip holding portion 51, and is fixedly held by the cap 4. The cap 4 absorbs the shock of writing pressure, which the pen tip portion 5 receives thereon into a direction in parallel with the writing surface 129. The upper housing portion 31 and the lower housing portion 32 are members, each of which defines a part of an exterior of the digital pen 1, having an approximately cylindrical shape, being divided into two (2) along an imaginary axis Ax passing through a center of the digital pen 1, and they build up a container configuration, opening at one end thereof when they are connected with. Also, there are provided a several number of fixing ribs 321 on an interior wall surface, so that parts within the housing can be fixedly received therein.

The cut-out portion 31a is provided on a griping portion, for the purpose of improving a grip feeling when it is put between a thumb and an index finger in writing, and also for preventing it from rotating because of a cause of reason beyond control when it is put on a table or desk.

The upper housing portion 31 is put on the lower housing portion 32, after storing the members mentioned above therein, and they are mechanically connected with, through a male screw, which is provided on one end, and a female joint, which is provided on an interior surface of the cap 4. The other end thereof is mechanically connected with, through press fitting of the pen rear tip 2, on which the hook 21 is provided.

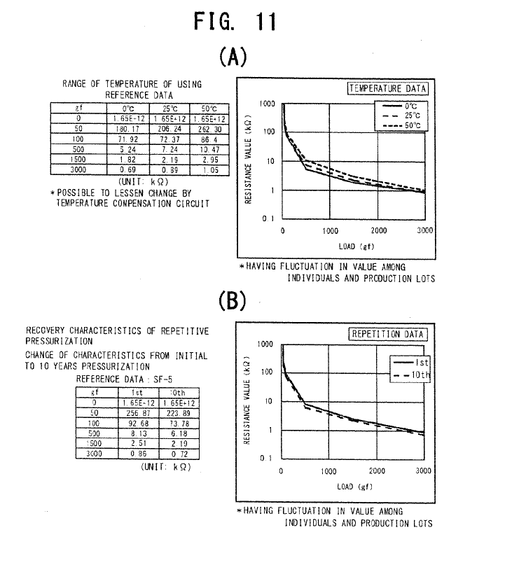

As a light emitting element 7 is applied a light emitting diode, for example, having such directional characteristics (e.g., diverging characteristics of the light) as shown in FIG. 10. Application of the light emitting diode brings about an effect that a lifetime thereof is long and a cost thereof can be suppressed down to be low.

As other light source may be an infrared laser diode, which has a small divergence angle, and is superior in the light conversion efficiency of energy. In this case, since the laser light is small in the divergence angle and is superior in the linearity thereof, it is preferable to apply a material having a high light divergence effect, as the pen tip holder portion 52, but it is also preferable to provide such directional characteristics Lhat the infrared directing to the light receiving portion 134 can be increased up.

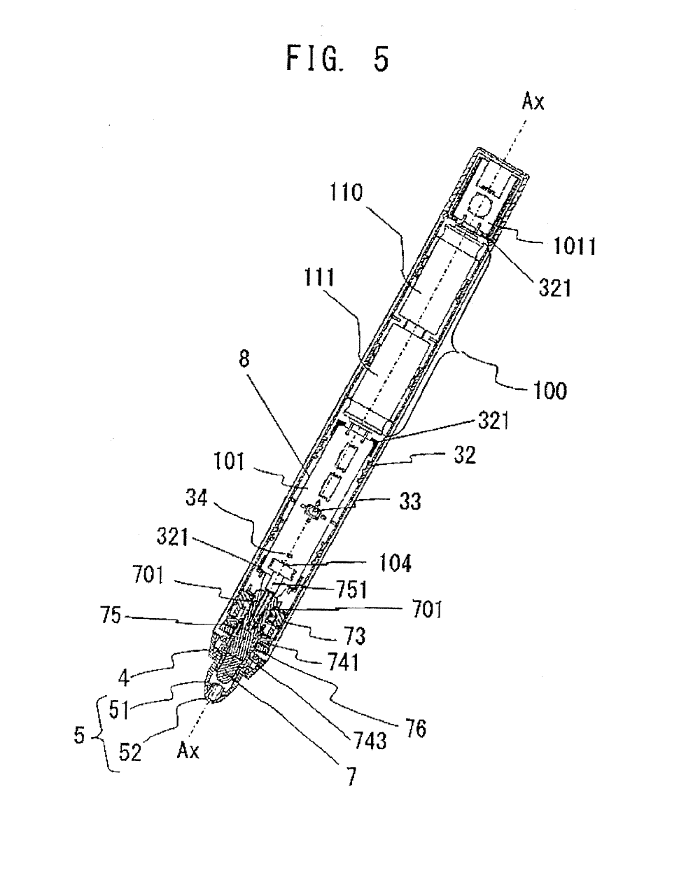

Further, the digital pen 1 has the approximately cylindrical shape thereof, for the purpose of receiving an EDLC (Electric Double Layer Capacitor) or a battery therein, as a power source for supplying electricity to the light emitting element 7. In FIG. 5 is shown an example, in which a controller circuit 1011 for controlling the power, bing supplied from an external power source, and two (2) pieces of batteries 110 and 111 are applied, as the EDLC 100.

The digital pen 1 is made up with a plural number of hollow members, which are aligned along with the imaginary axis Ax passing through the center of the pen tip portion 5. Inside the digital pen 1, the pen tip portion 5, the light emitting element and a detector portion 75 are disposed, in such sequential order thereof, from the writing surface 129.

FIG. 5 is a cross-section view of the digital pen. Herein, the light emitting element, the detector portion 75 and a base member 76, etc., are shown under the condition that they are exploded into the imaginary axis. The light emitting element 7 is positioned at the pen tip portion 5, and the light emission of which is controlled by a light emitting element driver circuit, which is provided on one surface of a circuit board 8 (being connected with a connector 103 of the light emitting element 7 through a connector 102). With this structure, the pen tip portion 5 can emit the infrared therefrom.

The light emitting element 7 is inserted into a first hollow member 71, from a side of the pen tip portion 5, and is fixed on a side end surface of the pen tip portion 5 of a cylindrical supporting member 713. On an outer peripheral portion of the supporting member 713 is provided a recess portion 711 having an elastic power, and when it slides along a cylindrical interior surface of a second hollow member 74 (being established by three (3) members 741, 742 and 743), that recess portion 711 fits into an opening portion 7421, being also provided on the cylindrical interior surface thereof in the similar manner. In this instance, one end of a spring member 72 is fixed on a wall surface, which is provided on the cylindrical surface of the second hollow member 74.

Also, the other end surface portion of the first hollow member 71 is divided into, approximately, in parallel with the imaginary axis Ax passing through the center of the digital pen 1, and on the outer peripheral portion thereof is provided a returning portion 712.

The light emitting element 7, the first hollow member 71 and the spring member 72 are inserted into the cylindrical second hollow member 74, extending along the imaginary axis Ax passing through the center of the digital pen 1, and are fixed within an inside of the second hollow member 74 with an aid of a fixing member 73. On a bottom surface of the fixing member 73 is provided a penetrating hole or opening 734, so that the returning portion 712, which is provided on the peripheral surface of the first hollow member 71 at the end surface thereof, is connected and fixed with the fixing portion 73, through insertion thereof into the penetrating opening 734.

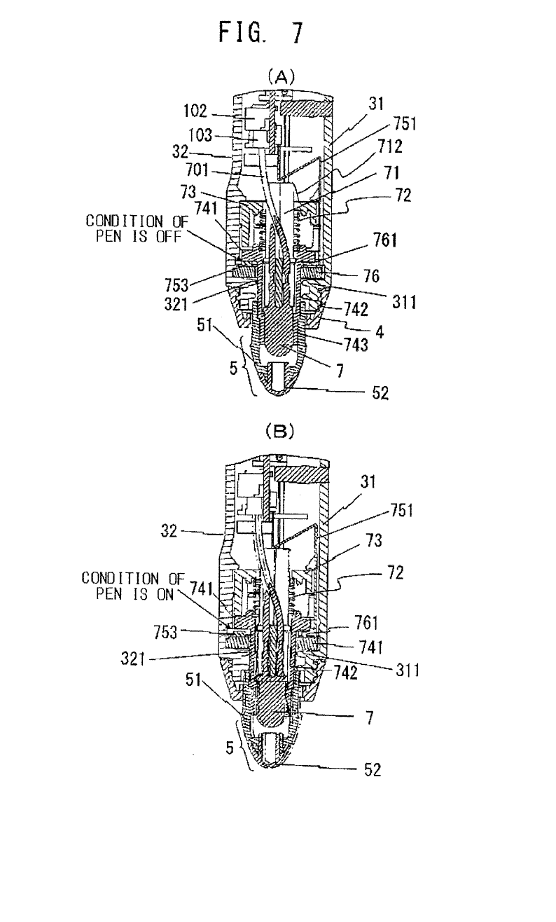

The light emitting element 7 is attached on the second hollow member 74, at one end portion thereof, facing to the pen tip, under the condition that a reed wire 701 is inserted into the second hollow member 74. Also, the reed wire 701 is drawn out from the other end portion of the second hollow member 74, so that it is electrically connected with a light emitting element driver board 102 (FIG. 7(A)) through the connectors 102 and 103.

The outer peripheral portion of the second hollow member 74 is thin at a pen tip side portion 743, on which the light emitting element 7 is fixed, in comparison to a central portion thereof, so as to insert the holding portion 51 of the pen tip 52 into this pen tip side portion 743, thereby to be held therein, and the position thereof in the direction of the imaginary axis Ax can be determined by an end surface of a step-wise portion, which is defined by the difference of an outer diameter, between a central portion 742 and the pen tip side portion 743.

Further, at the other end portion of the second hollow member 74 is formed an approximately disc-like hangover portion 741 hanging over into an outer periphery thereof. In a part of this hangover portion 741 is formed a cut-off portion 7411, recessing towards to the axis Ax, and passing through this cut-off portion 7411, a signal cable 751 is wound on a flat portion thereof, which is provided on the cylindrical surface of the fixing member 73, so that it is connected with a terminal 104 of a pressure-sensitive sensor of a pressure-sensitive sensor driver board 101, which is provided on the circuit board 8. Next, explanation will be given on the detector portion 75 for detecting contacting condition and writing pressure, when the pen tip 52 is in contact with the writing surface 129.

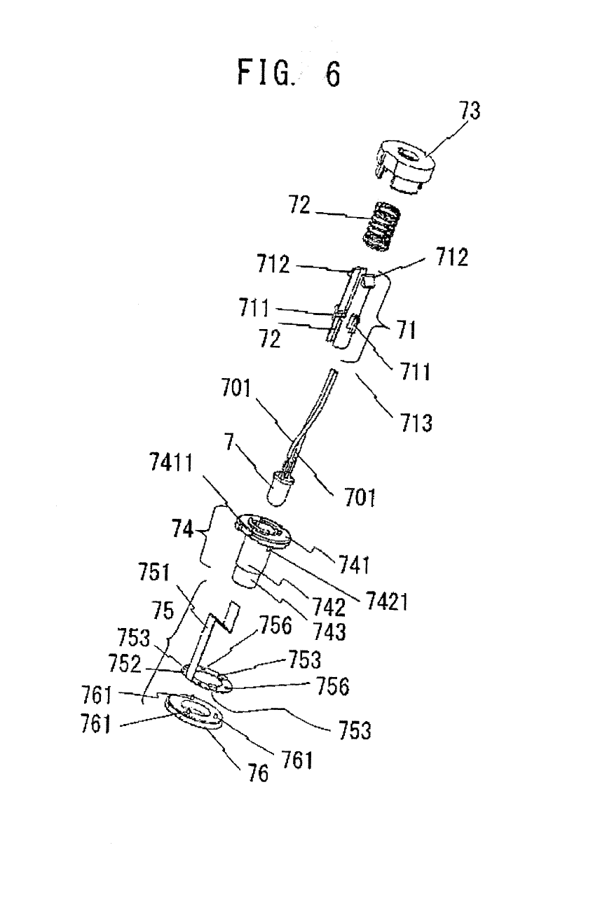

In FIG. 6, the detector portion 75 is constructed with the base member 76, a pressure-sensitive sensor fixing member 752, the signal cable 751, the first hollow member 71, the second hollow member 74 and the hangover portion 741. The base member 76 comprises three (3) pieces of pins 761 on a circular periphery thereof. The pressure-sensitive sensor fixing member 752 comprises three (3) pieces of pressure-sensitive sensors 753 and three (3) pieces of penetrating holes or openings 756, on a circular periphery thereof. Those three (3) pieces of penetrating openings 756 correspond to the three (3) pieces of pins mentioned above, and each of those pins is fitting to the respective one of the penetrating openings. With this structure, the position of the pressure-sensitive sensor fixing member 752 can be determined, and it is possible to apply pressure upon those pressure-sensitive sensors 753, to be approximately constant.

Those pressure-sensitive sensors 753 are held under the pressure, being approximately constant, between the pen tip surface on the hangover portion 741 of the second hollow member 74 and the base member 76, by the function of the spring member 72, which is provided on the outer peripheral portion of the first hollow member 71.

FIGS. 7(A) and 7(B) are interior structural views of the digital pen, wherein FIG. 7(A) shows the digital pen 1 in the condition of OFF (i.e., the condition where the pen tip portion 5 does not contact with the writing surface 129) and FIG. 7(B) shows the digital pen 1 in the condition of ON (i.e., the condition where the pen tip portion 5 contacts with the writing surface 129), respectively. In the case of FIG. 7(A), the constant pressure is applied on the pressure-sensitive sensors 753, while in the case of FIG. 7(B), the pressure due to the spring member 72 is not applied on the pressure-sensitive sensors 753.

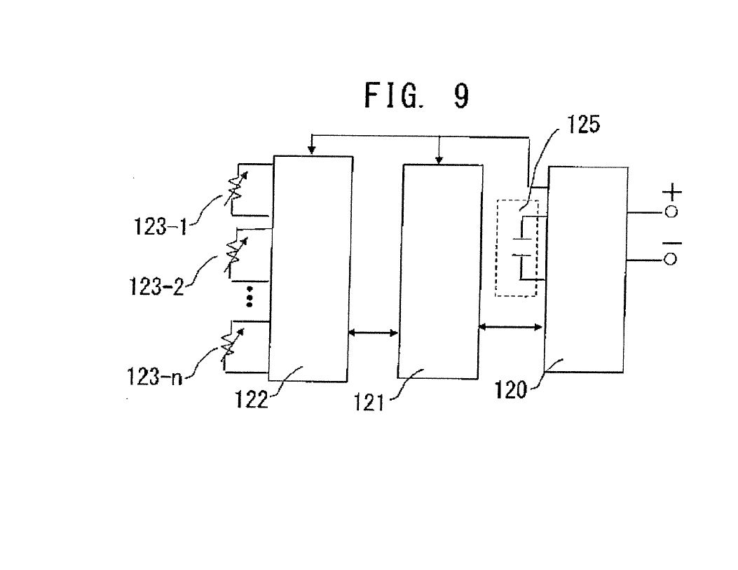

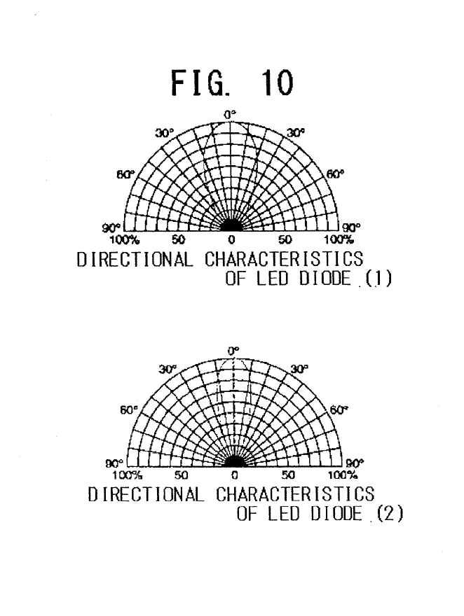

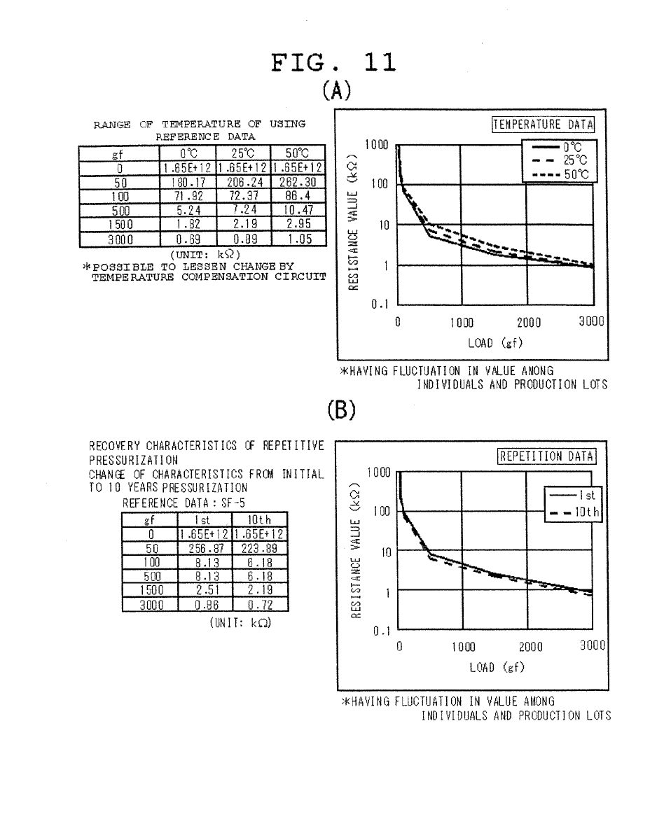

FIG. 9 is a circuit diagram, including a detector circuit 122 for detecting an output from the pressure-sensitive sensor. The detector circuit 122 is mounted on the light emitting element driver board 102 of the circuit board 8. A CPU (Central Processing Unit) 121 electrically detects if the digital pen 1 is in the ON condition or OFF condition, with comparison processing between the detected value and a value, which is determined in advance (i.e., comparing voltage changes of the plural numbers of pressure-sensitive sensor terminals 123). In more details, the CPU 121 determines that the digital pen 1 is in the OFF condition when the pressure due to the spring member 72 is applied upon the pressure-sensitive sensors 753, while it determines that the digital pen 1 is in the ON condition when no pressure due to the spring member 72 is applied upon the pressure-sensitive sensors 753. Thus, since detection can be made on the ON condition of the digital pen 1 when such pressure disappears while always applying the constant pressure upon the pressure-sensitive sensors 753; therefore, it is possible to reflect the track of the digital pen on the writing surface, as soon as possible, comparing to the method of detecting the ON condition of the digital pen by adding the pressure upon the pressure-sensitive sensor.

A reference numeral 125 depicts a power source of the digital pen 1, and as such is applied the EDLC, for the purpose of light weighting thereof, in a prototype manufactured by the inventors, and there can be achieved the structure for enabling to reduce electric charging thereof from an external power source and also fluctuation of the power source, etc., by means of a power source circuit 120.

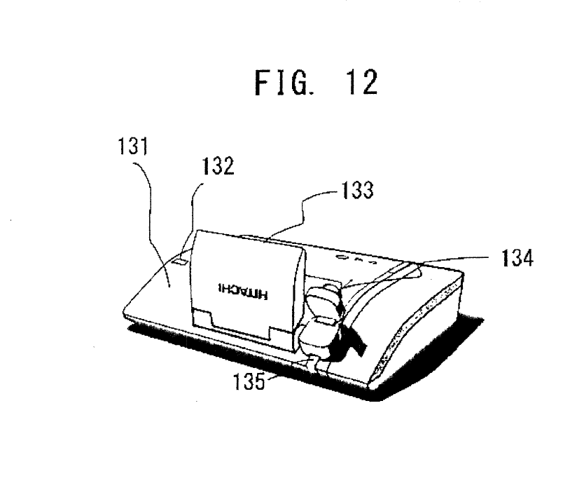

FIG. 11(A) is a view for showing the characteristics of a resistance-type pressure-sensitive sensor, which is applied as the pressure-sensitive sensor in an experiment made by the inventors, and this shows the resistance value changing with respect to the horizontal axis (i.e., load) of the graph. It is found out that detection can be made, clearly, between the ON condition and the OFF condition of the digital pen 1, if selecting the spring force of the spring member in such a manner that it can apply the spring force, being equal to or less than 500 gf, where an amount of change of the resistance value is large with respect to the change of the load. In the similar manner, if ambient temperature changes; i.e., 0 degree, 25 degrees, 50 degrees, sequentially, since the change of resistance value of the resistance-type pressure-sensitive sensor with respect to the load thereof has characteristics depending on the temperature, it is further preferable to select the spring force of the spring member in such a manner, that it can apply the spring force in a range equal to or less than 500 gf, where the characteristics are relatively stable.

FIG. 11(B) is a view for showing a result of study, i.e., how far the characteristics can be recovered, through repetitive pressurization of the resistance-type pressure-sensitive sensor mentioned above (herein, 10 times of pressurization), wherein the resistance value comes to be small even if applying the same load, after 10 times of the pressurization. For this reason, in case of not using the digital pen 1 at all (e.g., the case of keeping), it is preferable to provide a storage means for storing the digital pen 1 while pressurizing the pen tip thereof, continuously, not applying the load on the pressure-sensitive sensor; i.e., keeping the digital pen 1 in the OFF condition. With doing this, the spring member can be relieved from lowering down the spring force thereof.

On the other hand, in case where the digital pen is in the ON condition, i.e., the pen tip 5 is in contact with the writing surface 129, the pressure-sensitive sensor 753 is free from the pressure, which has been applied between the base member 76 of the detector portion 75 and the side surface of the pen tip of the hangover portion 741 of the second hollow member 74, due to the spring force of the spring member 72, which is provided on the outer peripheral portion of the first hollow member 71; thereby being in non-load condition. As a result of this, an output (i.e., the resistance value) from the resistance-type pressure-sensitive sensor comes to be nearly infinite, and this is detected by the detector circuit 122, in the similar manner as was mentioned above, i.e., the CPU 121 detects that the digital pen 1 is in the ON condition.

Further, in order to change the thickness of tracking information (i.e., thickness of the line drawn) of the digital pen 1, through detection of the writing pressure, with applying the region of being equal to or less than 500 gf, where an amount of the change is large with respect to the change of the load, it is possible to detect the change of the writing pressure in the form of the change of the resistance value. This can be detected by the detector circuit 122, in the similar manner to the mentioned above, and the CPU 121 electrically detects the writing pressure applied on the digital pen 1, with comparing the detected values with the values for the plural numbers of the writing pressures, which are determined in advance, in the processing thereof.

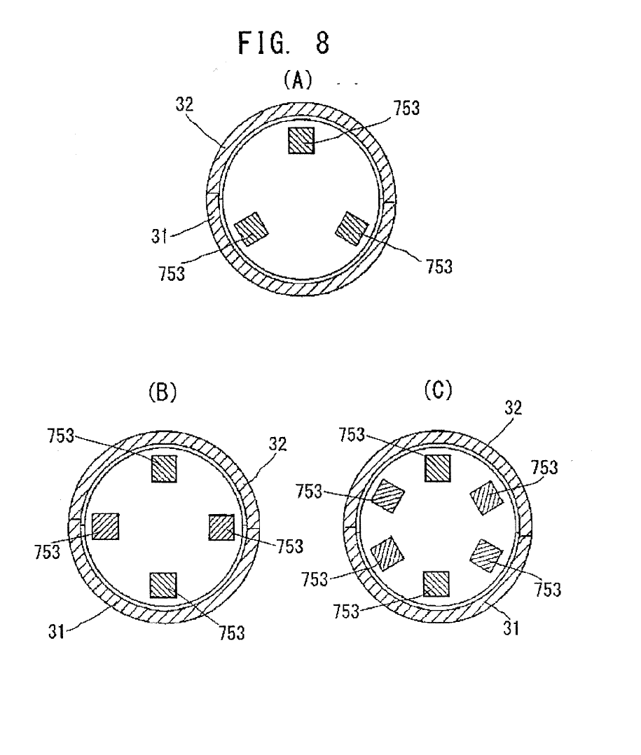

However, in the embodiment mentioned above, the explanation was given on the case of applying three (3) pieces of pressure-sensitive sensors therein (FIG. 8(A)); however, for detecting the writing pressure at an accuracy, much higher, or for presuming a moving direction of the pen in the future upon basis of the track of the digital pen 1, the number of the pressure-sensitive sensors may be increased up. For example, four (4) pieces of pressure-sensitive sensors may be disposed at every 90 degrees, while separating them equally in a circumferential direction, respectively (FIG. 8(B)), or for further increasing the detecting accuracy and the resolution power thereof, there may be provided six (6) pieces of pressure-sensitive sensors disposed at every 60 degrees, while separating them equally in the circumferential direction, respectively (FIG. 8(C)).

In the embodiment mentioned above, the base member 76 and receiving surfaces 311 and 321 of the housing are assumed to be the flat surfaces, each perpendicular to the imaginary axis Ax; however, the configurations of the base member 76 and receiving surfaces 311 and 321 of the housing may be the convex or concave surfaces projecting or recessing into the direction opposite to the pen tip, and also the configuration of the pen tip side surface of the hangover portion 741 may be the convex or concave surface. With this, the pen tip can be held between the pen tip side surface of the hangover portion 741 and the base member 76, with applying an approximately constant pressure thereon, by means of the spring force of the spring member 72; i.e., it is possible to apply the constant pressure on the pressure-sensitive sensors irrespective of a contact angle, even if the pen tip of the digital pen 1 contacts on the writing surface in an oblique direction.

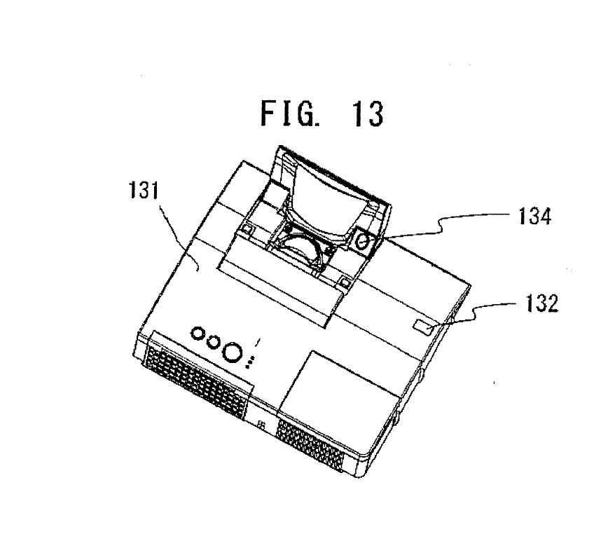

FIG. 12 is a view for showing the projection-type video display apparatus 131 of mirror folding-back type (hereinafter, may be also called “main body”) having a mirror 133 for guiding the picture on the screen. Herein is shown the main body 131, in the condition of being attached with the light receiving portion 134, externally (i.e., being fixed on an outside of the main body), by a fixing band 135.

In a portion of the light receiving portion 134, for building a semiconductor image pickup element therein, has such structure that it can be changed in an attaching angle thereof with respect to the main body 131. Further, for reducing erroneous operations, it is preferable to locate the light receiving portion 132 for receiving the light rays from a remote controller, and the light receiving portion 134 for receiving the light rays from the digital pen 1, on the planes differing from each other.

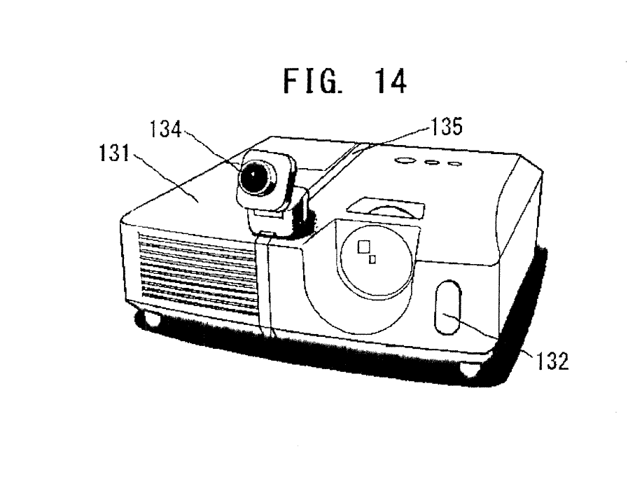

FIG. 13 is a view for showing other embodiment of the main body 131 of mirror folding-back type. Herein is shown the condition of building the light receiving portion 134 within the main body 131. The light receiving portion 134 is located in the vicinity of a projection lens (or, in the vicinity of an opening/closing portion of the mirror 133). Further, for reducing the erroneous operations, it is preferable to arrange those in such a manner that an angle, being defined between the optical axis of the super-wide angle lens of the light receiving portion 134 and a perpendicular line to the optical axis of the light receiving portion 132, comes to a predetermined angle.

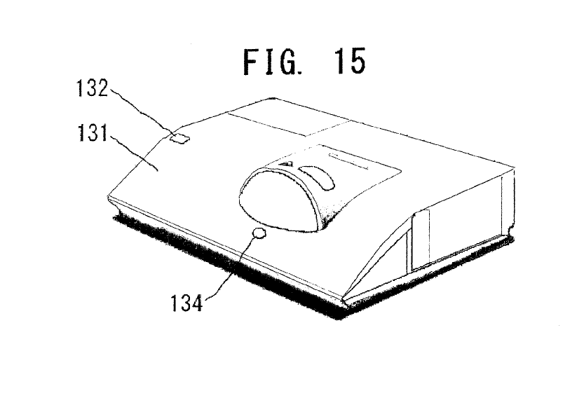

FIG. 14 is a view for showing a front surface projection video display apparatus 131. This is same to that shown in FIG. 12, excepting that this is not the mirror folding-back type.

FIG. 15 is a view for showing another embodiment of the front surface projection video display apparatus 131. This is same to that shown in FIG. 13, excepting that this is not the mirror folding-back type.

As was mentioned above, according to the present embodiments, since the ON condition of the digital pen can be detected when pressure disappears while always applying the constant pressure upon the pressure-sensitive sensors, it is possible to reflect the track of the digital pen on the writing surface, sooner, comparing to the method of detecting the ON condition of the digital pen by applying the pressure on the sensor. Also, there can be avoid the phenomenon that an amount of difference between the track written by the digital pen and a display picture relating to the writing position on the writing surface differs from, depending on the position of the picture. Also, it is possible to reflect the writing pressure when the pen tip contacts on the writing surface, quickly, on the thickness of the track drawn, as the display picture. Further, from the pen tip and the track written on the writing surface, it is also possible to detect the moving direction of the digital pen, soon.

Accordingly, it is possible to provide the digital pen for enabling writing with a feeling similar to that when the user writes characters or the like on a paper, with using a writing tool to be used normally, but without an uncomfortable feeling.

### EXPLANATION OF MARKS

1 . . . digital pen, 2 . . . end portion, 21 . . . hook, 31 . . . upper housing, 32 . . . lower housing, 31a . . . cut-out portion, 33 . . . external switch, 34 . . . display LED, 4 . . . cap, 5 . . . pen tip portion, 51 . . . pen tip holding portion, 52 . . . pen tip.

1. A digital pen, for outputting information relating to writing position, comprising:
a light emitting element, which is configured to emit a light ray of a specific wavelength region;
a pen tip portion, which is configured to emit said light ray on a writing surface of said digital pen;
a sensor, which is configured to output information indicative of whether said pen tip portion and said writing surface are in contact with or not;
a controller portion, which is configured to detect if said pen tip portion and said writing surface are in contact with or not, upon basis of the information outputted by said sensor; and
a holding mechanism, which is configured to hold pressure applied onto said sensor to be constant, through an elastic force of an elastic body, wherein
said controller portion determines that said pen tip portion and said writing surface are in contact with, when said sensor is free from the pressure, with which said sensor is held by said holding mechanism.

2. The digital pen, as described in the claim 1, further comprising plural numbers of hollow members, each extending along an imaginary axis passing through a center of said pen tip portion, wherein
said pen tip portion, said light emitting element, and said sensor are disposed, starting from said writing surface, in that sequential order thereof.

3. The digital pen, as described in claim 1, wherein
a first hollow member has said light emitting element at one end thereof, while a returning at the other end thereof, and a projecting portion on an outer wall surface thereof,
said elastic body is provided between said projecting portion and said returning,
a second hollow member is supported by a part of an interior wall surface so that said first hollow member is prevented from being inclined with respect to said imaginary axis, and further, at an end of said second hollow member is provided a cylindrical axis having an inner diameter being larger than an outer configuration of said first hollow member and being smaller than an outer configuration of said elastic body.

4. The digital pen, as described in claim 1, wherein said light emitting element is a light emitting diode.

5. The digital pen, as described in claim 1, wherein said is a piezo-resistive element.

6. A projection-type video display apparatus, comprising:
a digital pen, which is described in claim 1;
a light receiving portion, which is constructed with a wide angle lens and a semiconductor image pickup element; and
a display portion, which is configured to take a track of said light emitting point as picture information, by said semiconductor image pickup element, to detect a position of said digital pen through comparison with a format picture, which is produced in advance, and to display the track of said light emitting point, superimposing on an original picture displayed.
